(19) United States
(12) Patent Application Publication
(10) Pub. No.: US 2016/0072187 A1
(43) Pub. Date: Mar. 10, 2016

(54) APPARATUS AND METHODS FOR WIRELESS COMMUNICATION

(71) Applicant: NOKIA TECHNOLOGIES OY, Espoo (FI)

(72) Inventor: Aimo Arkko, Ruutana (FI)

(21) Appl. No.: 14/785,716

(22) PCT Filed: Apr. 22, 2013
(86) PCT No.: PCT/FI2013/050442

§ 371 Date: Oct. 20, 2015

(51) Int. Cl. H01Q 5/371; H01Q 21/30; H01Q 21/06

(52) U.S. Cl. CPC H01Q 5/371; H01Q 21/06; H01Q 21/30

(57) ABSTRACT

An apparatus comprising: a feed portion (28) configured to couple to radio frequency circuitry; a first antenna portion (30) coupled to the feed portion (28) and configured to resonate in a first operational frequency band; a second antenna portion (32) coupled to the feed portion (28) and configured to resonate in a second operational frequency band, the first antenna portion (30) and the second antenna portion (32) defining a perimeter (42); and a third antenna portion (34) coupled to the feed portion (28) at a first end and extending around the perimeter (42) defined by the first and second antenna portions, the third antenna portion (34) being configured to electromagnetically couple to the feed portion (28) at a second end and resonate in a third operational frequency band.

### TECHNOLOGICAL FIELD

Embodiments of the present invention relate to apparatus for wireless communication. In particular, they relate to apparatus for wireless communication in an electronic device.

### BACKGROUND

Apparatus, such as portable electronic communication devices, usually include at least one antenna for enabling wireless communication with other apparatus. For example, a mobile cellular telephone may include one or more antennas for enabling wireless communication with a base station. The apparatus may be required to operate in several operational frequency bands and consequently, the apparatus may require several antennas to enable operation over those frequency bands. However, the inclusion of several antennas may increase the volume of the apparatus, or may result in reduced space for other electronic components where the volume of the apparatus is predetermined.

It would therefore be desirable to provide an alternative apparatus.

### BRIEF SUMMARY

According to various, but not necessarily all, embodiments of the invention there is provided an apparatus comprising: a feed portion configured to couple to radio frequency circuitry; a first antenna portion coupled to the feed portion and configured to resonate in a first operational frequency band; a second antenna portion coupled to the feed portion and configured to resonate in a second operational frequency band, the first antenna portion and the second antenna portion defining a perimeter; and a third antenna portion coupled to the feed portion at a first end and extending around the perimeter defined by the first and second antenna portions, the third antenna portion being configured to electromagnetically couple to the feed portion at a second end and resonate in a third operational frequency band.

The feed portion may include: a feed point; and a first conductive part extending from the feed point, the third antenna portion being coupled to the feed point via the first conductive part.

The feed portion may include a second conductive part extending from the first conductive part, the first antenna portion and the second antenna portion being coupled to the feed point via the first conductive part and the second conductive part.

The first antenna portion may be configured to electromagnetically couple to the third antenna portion between the first and second ends of the third antenna portion.

The second antenna portion may have a first end coupled to the feed portion and a second end, the first antenna portion may be configured to electromagnetically couple to the second antenna portion between the first and second ends of the second antenna portion.

The first antenna portion may have a first end coupled to the feed portion and a second end, the second antenna portion may be configured to electromagnetically couple to the first antenna portion between the first and second ends of the first antenna portion.

The apparatus may further comprise a ground member, the feed portion, the first antenna portion, the second antenna portion and the third antenna portion may be in a non-overlaying arrangement with the ground member.

The first antenna portion and the third antenna portion may form a first G shaped antenna, and the first antenna portion and the second antenna portion may form a second G shaped antenna.

The third antenna portion may be configured to resonate in a first mode and in a second mode to provide two resonant frequency bands.

According to various, but not necessarily all, embodiments of the invention there is provided an electronic communication device comprising a first apparatus as described in any of the preceding paragraphs.

The electronic communication device may comprise a second apparatus as described in any of the preceding paragraphs. The first apparatus and the second apparatus may form a multiple input multiple output antenna arrangement.

The electronic device may further comprise a switch coupled between the first apparatus, the second apparatus and radio frequency circuitry.

According to various, but not necessarily all, embodiments of the invention there is provided a method comprising: providing a feed portion configured to couple to radio frequency circuitry; and providing: a first antenna portion coupled to the feed portion and configured to resonate in a first operational frequency band; a second antenna portion coupled to the feed portion and configured to resonate in a second operational frequency band, the first antenna portion and the second antenna portion defining a perimeter; and a third antenna portion coupled to the feed portion at a first end and extending around the perimeter defined by the first and second antenna portions, the third antenna portion being configured to electromagnetically couple to the feed portion at a second end and resonate in a third operational frequency band.

The feed portion may include: a feed point; and a first conductive part extending from the feed point, the third antenna portion may be coupled to the feed point via the first conductive part.

The feed portion may include a second conductive part extending from the first conductive part, the first antenna portion and the second antenna portion may be coupled to the feed point via the first conductive part and the second conductive part.

The first antenna portion may be configured to electromagnetically couple to the third antenna portion between the first and second ends of the third antenna portion.

The second antenna portion may have a first end coupled to the feed portion and a second end, the first antenna portion may be configured to electromagnetically couple to the second antenna portion between the first and second ends of the second antenna portion.

The first antenna portion may have a first end coupled to the feed portion and a second end, the second antenna portion may be configured to electromagnetically couple to the first antenna portion between the first and second ends of the first antenna portion.

The method may further comprise providing a ground member, and positioning the feed portion, the first antenna portion, the second antenna portion and the third antenna portion in a non-overlaying arrangement with the ground member.

The first antenna portion and the third antenna portion may form a first G shaped antenna, and the first antenna portion and the second antenna portion may form a second G shaped antenna.

The third antenna portion may be configured to resonate in a first mode and in a second mode to provide two resonant frequency bands.

### BRIEF DESCRIPTION

For a better understanding of various examples that are useful for understanding the brief description, reference will now be made by way of example only to the accompanying drawings in which:

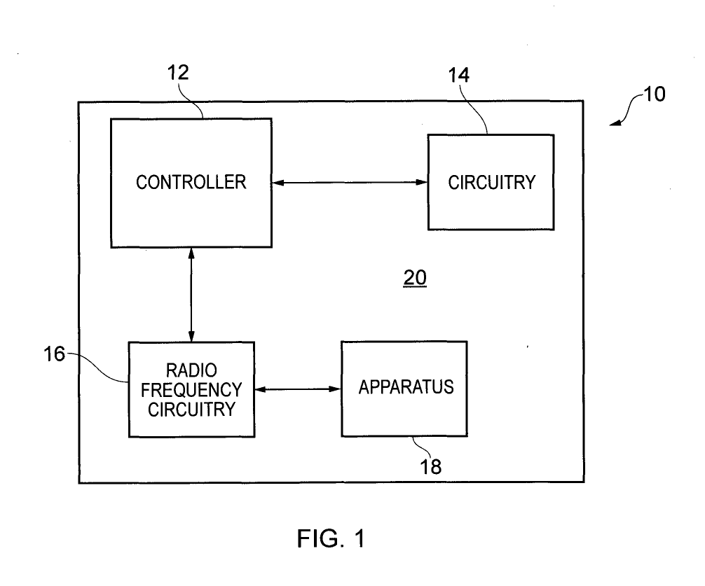

FIG. 1 illustrates a schematic diagram of an electronic device according to various examples;

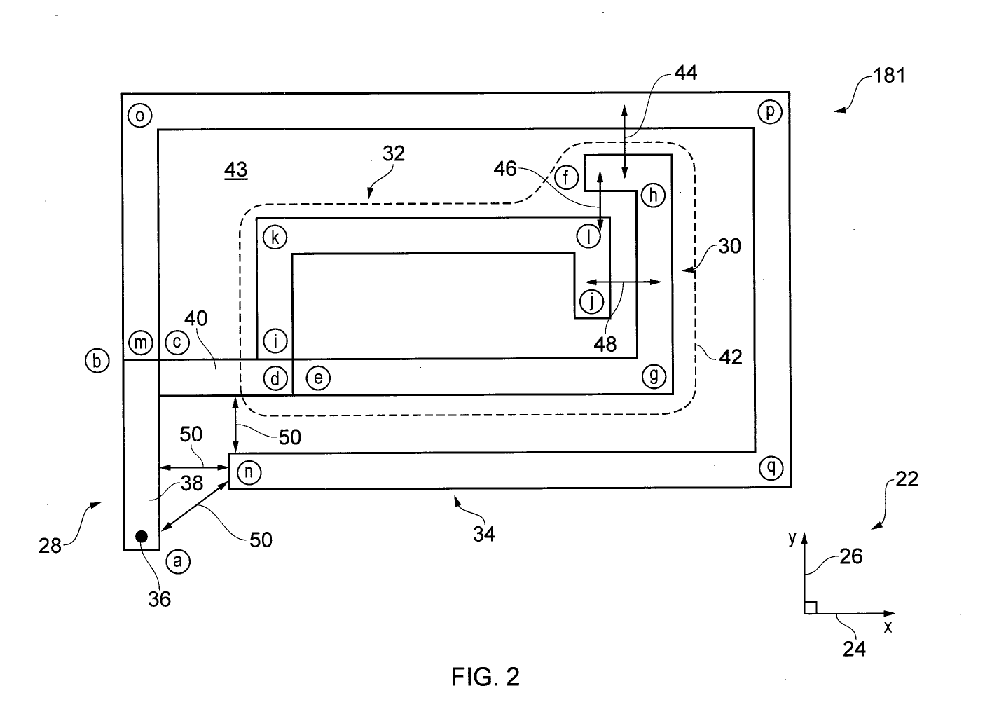

FIG. 2 illustrates a plan view of an apparatus according to various examples;

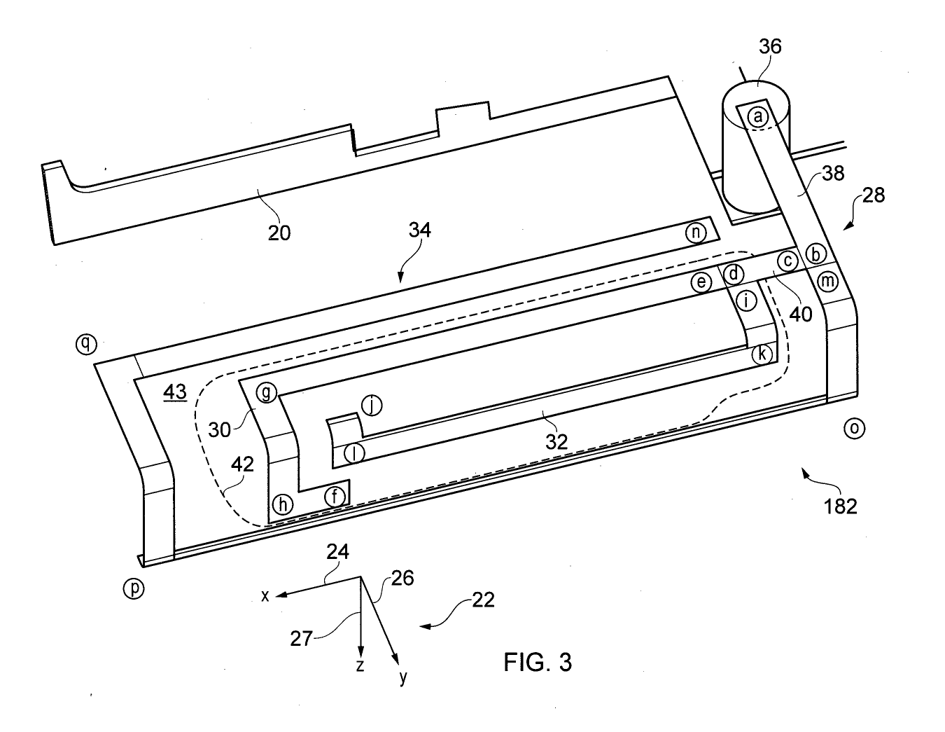

FIG. 3 illustrates a perspective view of another apparatus according to various examples;

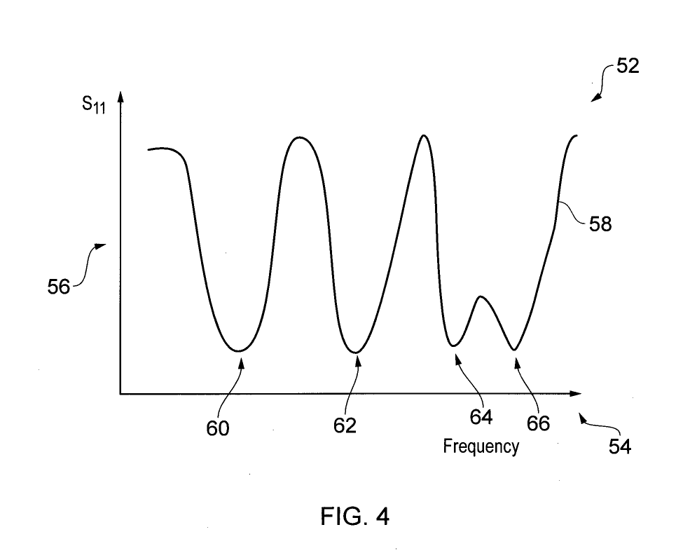

FIG. 4 illustrates a graph of scattering parameter S11 versus frequency for the apparatus illustrated in FIGS. 2 & 3;

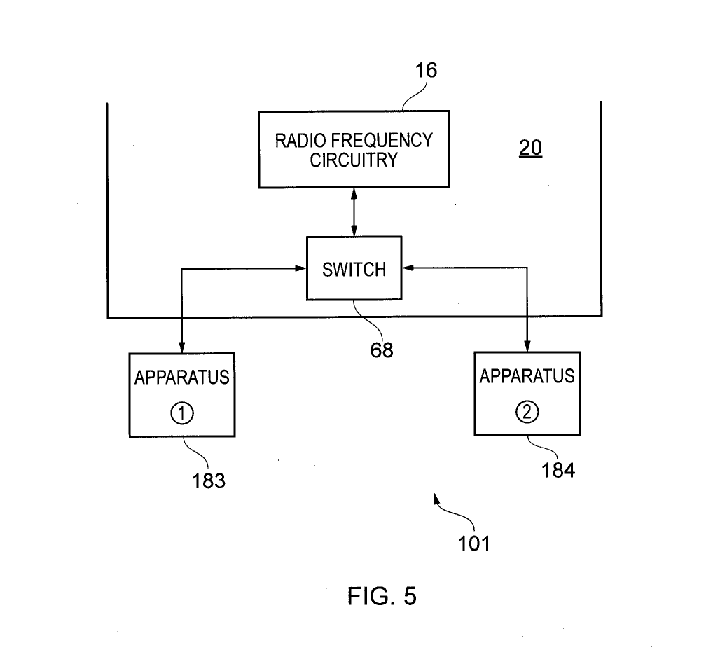

FIG. 5 illustrates a schematic diagram of another electronic device according to various examples; and

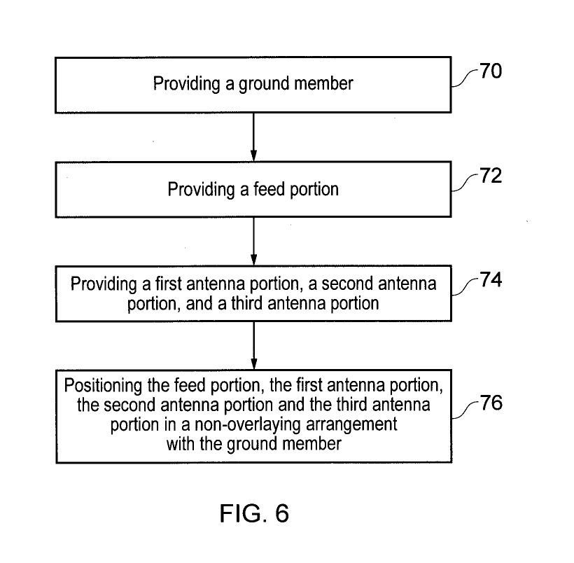

FIG. 6 illustrates a flow diagram of a method according to various examples.

### DETAILED DESCRIPTION

In the following description, the wording ‘connect’ and ‘couple’ and their derivatives mean operationally connected or coupled. It should be appreciated that any number or combination of intervening components can exist (including no intervening components). Additionally, it should be appreciated that the connection or coupling may be a physical galvanic connection and/or an electromagnetic connection.

FIGS. 2 and 3 illustrate an apparatus 181, 182 comprising: a feed portion 28 configured to couple to radio frequency circuitry 16; a first antenna portion 30 coupled to the feed portion 28 and configured to resonate in a first operational frequency band; a second antenna portion 32 coupled to the feed portion 28 and configured to resonate in a second operational frequency band, the first antenna portion 30 and the second antenna portion 32 defining a perimeter 42; and a third antenna portion 34 coupled to the feed portion 28 at a first end and extending around the perimeter 42 defined by the first and second antenna portions 30, 32, the third antenna portion 34 being configured to electromagnetically couple 50 to the feed portion 28 at a second end and resonate in a third operational frequency band.

FIG. 1 illustrates an electronic device 10 including a controller 12, circuitry 14, radio frequency circuitry 16, apparatus 18 and a ground member 20. The electronic device 10 may be any apparatus such as a portable electronic device (for example, a mobile cellular telephone, a tablet computer, a laptop computer, a personal digital assistant or a hand held computer), a non-portable electronic device (for example, a personal computer or a base station), a portable multimedia device (for example, a music player, a video player, a game console and so on) or a module for such devices. As used here, the term ‘module’ refers to a unit or apparatus that excludes certain parts or components that would be added by an end manufacturer or a user.

The implementation of the controller 12 can be in hardware alone (for example, a circuit, a processor and so on), have certain aspects in software including firmware alone or can be a combination of hardware and software (including firmware).

The controller 12 may be implemented using instructions that enable hardware functionality, for example, by using executable computer program instructions in a general-purpose or special-purpose processor that may be stored on a computer readable storage medium (disk, memory and so on) to be executed by such a processor.

The circuitry 14 includes additional electronic components of the electronic device 10. For example, the circuitry 14 may include input/output devices such as an audio input device (a microphone for example), an audio output device (a loudspeaker for example), user input devices (a touch screen display, a keypad, a keyboard and so on) and a display. The controller 12 is configured to control the operation of the circuitry 14.

The radio frequency circuitry 16 is connected between the controller 12 and the apparatus 18 and may include a receiver and/or a transmitter and/or a transceiver. The controller 12 is configured to provide signals to, and/or receive signals from the radio frequency circuitry 16.

The electronic device 10 may optionally include one or more matching circuits, lumped or distributed components (resistors, inductors and capacitors), filters, switches, transmission lines (microstrip, stripline, co-planar waveguide, waveguide, coaxial cable, as non-limiting examples), semi-conductor devices (diodes, bipolar transistors or field effect transistors, as non-limiting examples) or other radio frequency circuit elements, and combinations thereof, between the radio frequency circuitry 16 and the apparatus 18.

The apparatus 18 may also be referred to as an ‘antenna’ or an ‘antenna arrangement’ and is configured to enable the electronic device 10 to wirelessly communicate with other electronic devices. The apparatus 18 is described in detail in the following paragraphs with reference to various examples.

The radio frequency circuitry 16 and the antenna 18 may be configured to operate in a plurality of operational frequency bands. For example, the operational frequency bands may include (but are not limited to) Long Term Evolution (LTE) (US) (734 to 746 MHz and 869 to 894 MHz), Long Term Evolution (LTE) (rest of the world) (791 to 821 MHz and 925 to 960 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); hiper local area network (HiperLAN) (5150-5850 MHz); global positioning system (GPS) (1570.42-1580.42 MHz); US-Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); time division synchronous code division multiple access (TD-SCDMA) (1900 MHz to 1920 MHz, 2010 MHz to 2025 MHz), ultra wideband (UWB) Lower (3100-4900 MHz); UWB Upper (6000-10600 MHz); digital video broadcasting-handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz).

A frequency band over which an antenna can efficiently operate is a frequency range where the antenna's return loss and radiation efficiency are better than defined operational thresholds. For example, efficient operation may occur when the antenna's return loss is better than (that is, more than) 4 dB or 6 dB, and the radiation efficiency is better than (that is, more than) −3 dB or −1 dB.

The apparatus 18, the electronic components that provide the radio frequency circuitry 16, the circuitry 14 and the controller 12 may be interconnected via the ground member 20 (for example, a printed wiring board). In some examples, the ground member 20 may be formed from several conductive parts of the electronic device 10, one part of which may include the printed wiring board. For example, at least a part of the ground member 20 may comprise at least a portion of an external conductive housing of the electronic device 10, the at least one portion of the external conductive housing may or may not be coupled to a printed wiring board. The ground member 20 may be planar or non-planar.

FIG. 2 illustrates a plan view of an apparatus 181 and a Cartesian coordinate axis 22 that includes an X axis 24 and a Y axis 26 that are orthogonal relative to one another. The apparatus 181 includes a feed portion 28, a first antenna portion 30, a second antenna portion 32 and a third antenna portion 34. The apparatus 181 has a dual G shaped antenna structure where the first antenna portion 30 and the third antenna portion 34 form a first G shaped antenna, and the first antenna portion 30 and the second antenna portion 32 form a second G shaped antenna. In this example, the apparatus 181 is planar. However, in other examples, the apparatus 181 may extend in three dimensions and be non-planar (as illustrated in FIG. 3).

The feed portion 28 includes a feed point 36, a first conductive part 38 and a second conductive part 40. The first conductive part 38 includes a first end (a) and a second end (b). The feed point 36 is coupled to the first conductive part 38 at the first end (a). The first conductive part 38 extends from the feed point 36 in the +Y direction until the second end (b). The second conductive part 40 includes a first end (c) and a second end (d). The first end (c) of the second conductive part 40 is coupled to the second end (b) of the first conductive part 38, and the second conductive part 40 extends in the +X direction until the second end (d).

The first antenna portion 30 has a first end (e) and a second end (f), the second end (f) being an open end. The first end (e) of the first antenna portion 30 is coupled to the second end (d) of the second conductive part 40. The first antenna portion 30 extends from the first end (e) in the +X direction until position (g) and then extends in the +Y direction until position (h). The first antenna portion 30 extends from position (h) in the −X direction until the second end (f).

The second antenna portion 32 has a first end (i) and a second end (j), the second end (j) being an open end. The first end (i) of the second antenna portion 32 is coupled to the second end (d) of the second conductive part 40. The second antenna portion 32 extends from the first end (i) in the +Y direction until position (k) and then extends in the +X direction until position (I). The second antenna portion 32 then extends from position (I) in the −Y direction until the second end (j).

The third antenna portion 34 has a first end (m) and a second end (n), the second end (n) being an open end. The first end (m) of the third antenna portion 34 is coupled to the second end (b) of the first conductive part 38. The third antenna portion 34 extends from the first end (m) in the +Y direction until position (o) and then extends in the +X direction until position (p). The third antenna portion 34 then extends from position (p) in the −Y direction until position (q). The third antenna portion 34 extends from the position (q) in the −X direction until the second end (n). The second end (n) of the third antenna portion 34 is located in proximity to the feed portion 28.

As illustrated by the dotted line 42, the first antenna portion 30 and the second antenna portion 32 define a perimeter about which the third antenna portion 34 extends around. In more detail, the exterior surface of the first antenna portion 30 between positions (e), (g), (h) and (f), and the exterior surface of the second antenna portion 32 between positions (i), (k) and (I) defines the perimeter 42 and the third antenna portion 34 extends around the perimeter 42 between the first and second ends (m), (n). Consequently, the third antenna portion 34 may be considered to wrap around and thereby enclose the first and second antenna portions 30, 32.

The third antenna portion 34 may also be considered to define an aperture 43 therein, and the first and second antenna portions 30, 32 are positioned within the aperture defined by the third antenna portion 34.

The first antenna portion 30 is configured to electromagnetically couple to the third antenna portion 34 between the first and second ends (m), (n) of the third antenna portion 34. In more detail, the second end (f) of the first antenna portion 30 is positioned in proximity to the third antenna portion 34 between positions (o) and (p) and electromagnetically couples to the third antenna portion 34 (indicated by the arrow with reference numeral 44). Consequently, the first antenna portion 30 and the third antenna portion 34 may be considered to form a capacitively coupled loop path via the electromagnetic coupling.

The first antenna portion 30 is also configured to electromagnetically couple to the second antenna portion 32 between the first and second ends (i), (j) of the second antenna portion 32. In more detail, the second end (f) of the first antenna portion 30 is positioned in proximity to the second antenna portion 32 at position (I) and electromagnetically couples to the second antenna portion 32 (indicated by the arrow with reference numeral 46). Consequently, the first antenna portion 30 and the second antenna portion 32 may be considered to form a capacitively coupled loop path via the electromagnetic coupling.

The second antenna portion 32 is configured to electromagnetically couple to the first antenna portion 30 between the first and second ends (e), (f) of the first antenna portion 30. In more detail, the second end (j) of the second antenna portion 32 is positioned in proximity to the first antenna portion 30 between positions (g) and (h) and electromagnetically couples to the first antenna portion 30 (indicated by the arrow with reference numeral 48). Consequently, the second antenna portion 32 and the first antenna portion 30 may be considered to form a capacitively coupled loop path via the electromagnetic coupling.

The third antenna portion 34 is configured to electromagnetically couple to the feed portion 28 at the second end (n). In more detail, the second end (n) of the third antenna portion 34 is positioned in proximity to the feed point 36, the first conductive part 38 and the second conductive part 40 and electromagnetically couples to the feed point 36, the first conductive part 38 and the second conductive part 40 (indicated by the arrows with reference numeral 50). Consequently, the third antenna portion 34 and the feed portion 28 may be considered to form a capacitively coupled loop path via the electromagnetic coupling.

FIG. 3 illustrates a perspective view diagram of another apparatus 182 and the Cartesian coordinate system 22. The apparatus 182 is similar to the apparatus 181 illustrated in FIG. 2 and where the features are similar, the same reference numerals and letters are used. The Cartesian coordinate system 22 also includes a Z axis 27 that is orthogonal to the X axis 24 and to the Y axis 26.

The apparatus 182 differs from the apparatus 181 in that the apparatus 182 is non-planar and extends in three dimensions.

In more detail, the first and second conductive parts 38, 40 of the feed portion 28 are generally oriented parallel relative to the X-Y plane.

The first antenna portion 30 is generally oriented parallel to the X-Y plane between the first end (e) and the position (g), extends in the +Z direction between positions (g) and (h), and is generally oriented parallel to the X-Z plane between the position (h) and the second end (f).

The second antenna portion 32 is generally oriented parallel to the X-Y plane between the first end (i) and the position (k), extends in the +Z direction between positions (i) and (k) and is generally oriented parallel to the X-Z plane between the position (k) and the second end (j).

The third antenna portion 34 generally extends in the +Z direction from the first end (m) and is generally oriented parallel to the X-Z plane between positions (m) and (p). The third antenna portion 34 extends in the −Z direction from position (p), and is generally oriented parallel to the X-Y plane between positions (q) and (n).

As illustrated in FIG. 3, the feed portion 28, the first antenna portion 30, the second antenna portion 32 and the third antenna portion 34 are in a non-overlaying relationship with the ground member 20. In other examples, some or all of the feed portion 28, the first antenna portion 30, the second antenna portion 32 and the third antenna portion 34 may overlay the ground member 20.

FIG. 4 illustrates a graph 52 of the magnitude of the scattering parameter S11 versus frequency for the apparatus illustrated in FIGS. 2 & 3. The graph 52 includes a horizontal axis 54 for frequency and a vertical axis 56 for the magnitude of the scattering parameter S11. The graph 52 also includes a line 58 that represents how the magnitude of the scattering parameter S11 of the apparatus 181, 182 varies with frequency.

The line 58 includes a first minimum 60 at a first frequency, a second minimum 62 at a second frequency (higher than the first frequency), a third minimum 64 at a third frequency (higher than the second frequency) and a fourth minimum 66 at a fourth frequency (higher than the third frequency).

The first minimum 60 corresponds to an operational frequency band of a first mode (where electrical length L=λ/4) of the third antenna portion 34. The second minimum 62 corresponds to an operational frequency band of the first antenna portion 30. The third minimum 64 corresponds to an operational frequency band of the second antenna portion 32. The fourth minimum 66 corresponds to an operational frequency band of a second mode (where electrical length L=3λ/4) of the third antenna portion 34.

The frequency of the first minimum 60 is determined at least in part by the electrical length of the third antenna portion 34 and the electromagnetic coupling indicated by reference numerals 44 and 50. The frequency of the second minimum 62 is determined at least in part by the electrical length of the first antenna portion 30 and the electromagnetic coupling indicated by reference numerals 44 and 48. The frequency of the third minimum 64 is determined at least in part by the electrical length of the second antenna portion 32 and the electromagnetic coupling indicated by reference numerals 46 and 48. The frequency of the fourth minimum 66 is determined at least in part by the electrical length of the third antenna portion 34 and the electromagnetic coupling indicated by reference numerals 44 and 50.

The electromagnetic coupling indicated by reference numerals 44 and 50 advantageously provides the second mode of the third antenna portion 34 with a relatively low scattering parameter magnitude that enables the third antenna portion 34 to operate in at least two operational frequency bands. The second mode of the third antenna portion 34 may be tuned so that the fourth minimum 66 is relatively close in frequency to the third minimum 64 and thereby provides a relatively wide bandwidth in conjunction with the third minimum 64 (the combination of the third and fourth minimums 64, 66 enabling operation in one or two operational frequency bands).

The apparatus 181, 182 may have a relatively low volume and advantageously enable operation in four resonant frequencies (which may correspond to three or four operational frequency bands). For example, the dimensions of the apparatus 181 may be 23 mm×14 mm and the apparatus 181 is operable as an LTE antenna. By way of a further example, the dimensions of the apparatus 182 may be 23 mm×10 mm×4 mm and the apparatus 182 is operable as an LTE antenna.

The coupling distances may be relatively close for electromagnetic coupling regions 44, 46 & 48 (less than 1 mm in this example). For electromagnetic coupling region 50, the coupling distances may be larger (several mm) than the distances for electromagnetic coupling regions 44, 46, 48.

FIG. 5 illustrates a schematic diagram of another electronic device 101 according to various examples. The electronic device 101 is similar to the electronic device 10 and where the features are similar, the same reference numerals are used. The electronic device 101 differs from the electronic device 10 in that the electronic device 101 further comprises a switch 68 and a first apparatus 183 and a second apparatus 184.

The first apparatus 183 may be structured as illustrated in FIG. 2 or as illustrated in FIG. 3, or may have an alternative structure. Additionally, the second apparatus 184 may be structured as illustrated in FIG. 2 or as illustrated in FIG. 3, or may have an alternative structure.

The switch 68 may be any suitable switch and may be a double pole double throw (DPDT) switch. The switch 68 is interconnected between the first apparatus 183, the second apparatus 184 and the radio frequency circuitry 16. The switch 68 is configured to switch the functionality of the apparatus 183, 184. For example, where the first apparatus 183 and the second apparatus 184 form multiple input multiple output (MIMO) antennas, the switch 68 is configured to swap the main and MIMO branches between the first and second apparatus 183, 184. The controller 12 may be configured to control the switching of the switch 68.

FIG. 6 illustrates a flow diagram of a method according to various examples. At block 70, the method includes providing a ground member 20.

At block 72, the method includes providing at least a part of the feed portion 28. For example, block 72 may include the provision of the feed point 36 on the ground member 20.

At block 74, the method includes providing a first antenna portion 30, a second antenna portion 32 and a third antenna portion 34. Where the feed portion 28 includes the first conductive part 38 and/or the second conductive part 40, those sections of the feed portion 28 may be provided at block 74 where they are integral with the first antenna portion 30, the second antenna portion 32 and the third antenna portion 34.

At block 76, the method may include positioning the feed portion 28, the first antenna portion 30, the second antenna portion 32 and the third antenna portion 34 in a non-overlaying relationship with the ground member 20. In other examples, block 76 may include positioning one or more of the feed portion 28, the first antenna portion 30, the second antenna portion 32 and the third antenna portion 34 in an overlaying relationship with the ground member 20

The blocks illustrated in the FIG. 6 may represent steps in a method and/or sections of code in a computer program. For example, a controller may execute a computer program to control machinery to perform the method illustrated in FIG. 6. The illustration of a particular order to the blocks does not necessarily imply that there is a required or preferred order for the blocks and the order and arrangement of the block may be varied. Furthermore, it may be possible for some blocks to be omitted.

It will be appreciated that the examples given may be manufactured as distinct antennas as part of a specific fabrication process, in other words each of the first, second and third antenna portions 30, 32 and 34, including none, some or all of the feed portions 38 and 40, may be fabricated by distinct fabrication processes. As an example, the first antenna 30 may be manufactured using a flexi, semi-flexi or rigid printed wiring board (PWB) process, the second antenna 32 by a laser direct structuring (LDS) process and the third antenna 34 by a formed sheet metal process, if so desired, or alternatively all of the antenna portions 30, 32 and 34 may be manufactured by only one of the example manufacturing processes, and not limited to such processes. One or more of the feed and/or antenna portions 30, 32, 34, 38 and 40 may be at least a part of a housing of an electronic device. The first, second and third antenna portions 30, 32 and 34, including or excluding any of the feed portions 38 and 40, may be manufactured as an antenna module which may be a distinct physical unit capable of being inserted into and out of an electronic device. Any or all of the feed and/or antenna portions 30, 32, 34, 38 and 40 may be mechanically supported by a substrate which is non-conductive, for example, a PWB substrate like FR4, or a plastic molded support structure, as non-limiting examples. Any or all of the feed and/or antenna portions 30, 32, 34, 38 and 40 may be wholly integrated with a main PWB or may be separate distinct components or modules thereof.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed. For example, the feed portion 28, the first antenna portion 30, the second antenna portion 32 and the third antenna portion 34 may have different shapes to those illustrated in FIGS. 2 and 3.

In some examples, the first antenna portion 30 may not be configured to electromagnetically couple to the second antenna portion 32 between the first and second ends (i), (j) of the second antenna portion 32. That is, the second end (f) of the first antenna portion 30 may be positioned away from the second antenna portion 32 and consequently, electromagnetic coupling region 46 does not exist (or does not exist strongly) in these examples. Therefore, the frequency of the third minimum 64 in these examples is determined at least in part by the electrical length of the second antenna portion 32 and the electromagnetic coupling indicated by reference numeral 48.

In some examples, the feed portion 28 may only comprise the feed point 36 and may not include the first conductive part 38 and the second conductive part 40. In other examples, the feed portion 28 may include the feed point 36 and only one of the first conductive part 38 and the second conductive part 40.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1-21. (canceled)

22. An apparatus comprising:
a feed portion configured to couple to radio frequency circuitry;
a first antenna portion coupled to the feed portion and configured to resonate in a first operational frequency band;
a second antenna portion coupled to the feed portion and configured to resonate in a second operational frequency band, the first antenna portion and the second antenna portion defining a perimeter; and
a third antenna portion coupled to the feed portion at a first end and extending around the perimeter defined by the first and second antenna portions, the third antenna portion being configured to electromagnetically couple to the feed portion at a second end and resonate in a third operational frequency band, and wherein the second end of the third antenna comprises an open end and the third antenna portion is configured to define an aperture and the first and second antenna portions are positioned within the aperture defined by the third antenna portion.

23. An apparatus as claimed in claim 22, wherein the feed portion includes: a feed point; and a first conductive part extending from the feed point, the third antenna portion being coupled to the feed point via the first conductive part.

24. An apparatus as claimed in claim 23, wherein the feed portion includes a second conductive part extending from the first conductive part, the first antenna portion and the second antenna portion being coupled to the feed point via the first conductive part and the second conductive part.

25. An apparatus as claimed in claim 22, wherein the first antenna portion is configured to electromagnetically couple to the third antenna portion between the first and second ends of the third antenna portion.

26. An apparatus as claimed in claim 22, wherein the second antenna portion has a first end coupled to the feed portion and a second end, the first antenna portion being configured to electromagnetically couple to the second antenna portion between the first and second ends of the second antenna portion.

27. An apparatus as claimed in claim 22, wherein the first antenna portion has a first end coupled to the feed portion and a second end, the second antenna portion being configured to electromagnetically couple to the first antenna portion between the first and second ends of the first antenna portion.

28. An apparatus as claimed in claim 22, further comprising a ground member, the feed portion, the first antenna portion, the second antenna portion and the third antenna portion being in a non-overlaying arrangement with the ground member.

29. An apparatus as claimed in claim 22, wherein the first antenna portion and the third antenna portion form a first G shaped antenna, and the first antenna portion and the second antenna portion form a second G shaped antenna.

30. An apparatus as claimed in claim 22, wherein the third antenna portion is configured to resonate in a first mode and in a second mode to provide two resonant frequency bands.

31. An electronic communication device comprising a first apparatus, the first apparatus comprising:
a feed portion configured to couple to radio frequency circuitry;
a first antenna portion coupled to the feed portion and configured to resonate in a first operational frequency band;
a second antenna portion coupled to the feed portion and configured to resonate in a second operational frequency band, the first antenna portion and the second antenna portion defining a perimeter; and
a third antenna portion coupled to the feed portion at a first end and extending around the perimeter defined by the first and second antenna portions, the third antenna portion being configured to electromagnetically couple to the feed portion at a second end and resonate in a third operational frequency band, and wherein the second end of the third antenna comprises an open end and the third antenna portion is configured to define an aperture and the first and second antenna portions are positioned within the aperture defined by the third antenna portion.

32. An electronic communication device as claimed in claim 31, comprising a second apparatus comprising similar elements as recited in the first apparatus, wherein the first apparatus and the second apparatus form a multiple input multiple output antenna arrangement.

33. An electronic communication device as claimed in claim 32, further comprising a switch coupled between the first apparatus, the second apparatus and radio frequency circuitry.

34. A method comprising:
providing a feed portion configured to couple to radio frequency circuitry; and
providing: a first antenna portion coupled to the feed portion and configured to resonate in a first operational frequency band; a second antenna portion coupled to the feed portion and configured to resonate in a second operational frequency band, the first antenna portion and the second antenna portion defining a perimeter; and a third antenna portion coupled to the feed portion at a first end and extending around the perimeter defined by the first and second antenna portions, the third antenna portion being configured to electromagnetically couple to the feed portion at a second end and resonate in a third operational frequency band, and wherein the second end of the third antenna comprises an open end and the third antenna portion is configured to define an aperture and the first and second antenna portions are positioned within the aperture defined by the third antenna portion.

35. A method as claimed in claim 34, wherein the feed portion includes: a feed point; and a first conductive part extending from the feed point, the third antenna portion being coupled to the feed point via the first conductive part.

36. A method as claimed in claim 35, wherein the feed portion includes a second conductive part extending from the first conductive part, the first antenna portion and the second antenna portion being coupled to the feed point via the first conductive part and the second conductive part.

37. A method as claimed in claim 34, wherein the first antenna portion is configured to electromagnetically couple to the third antenna portion between the first and second ends of the third antenna portion.

38. A method as claimed in claim 34, wherein the second antenna portion has a first end coupled to the feed portion and a second end, the first antenna portion being configured to electromagnetically couple to the second antenna portion between the first and second ends of the second antenna portion.

39. A method as claimed in claim 34, wherein the first antenna portion has a first end coupled to the feed portion and a second end, the second antenna portion being configured to electromagnetically couple to the first antenna portion between the first and second ends of the first antenna portion.

40. A method as claimed in claim 34, further comprising providing a ground member, and positioning the feed portion, the first antenna portion, the second antenna portion and the third antenna portion in a non-overlaying arrangement with the ground member.

41. A method as claimed in claim 34, wherein the first antenna portion and the third antenna portion form a first G shaped antenna, and the first antenna portion and the second antenna portion form a second G shaped antenna.

42. A method as claimed in claim 34, wherein the third antenna portion is configured to resonate in a first mode and in a second mode to provide two resonant frequency bands.
